(19) United States
(12) Patent Application Publication
(10) Pub. No.: US 2022/0198292 A1
(43) Pub. Date: Jun. 23, 2022

(54) AUTOMATION OF VIRTUAL ASSISTANT TRAINING

(71) Applicant: International Business Machines Corporation, Armonk, NY (US)

(72) Inventors: Nicolo Sgobba, Fasano (IT); Erik Rueger, Ockenheim (DE); Michal Paluch, Kraków (PL); Nedin Ametovski, Skopje (MK)

(21) Appl. No.: 17/128,399

(22) Filed: Dec. 21, 2020

(51) Int. Cl. G06N 5/04; G06N 3/00; G06N 20/00

(52) U.S. Cl. CPC G06N 5/04; G06N 20/00; G06N 3/006

(57) ABSTRACT

A question and answer pair is received from an external knowledge base. From the question, a set of intents is extracted. Whether the set of intents exceeds a match threshold with a subset of a plurality of intents within an internal knowledge base is determined. In response to determining a match threshold success, associating the question with the subset of intents within the plurality. A virtual assistant is trained to answer the question using the subset of intents.

### BACKGROUND

The present disclosure relates generally to the field of virtual assistants, and more particularly to automated training of virtual assistants.

Virtual assistants are conversational, computer-generated characters that can simulate a conversation to deliver voice and/or text-based information to a user. Traditionally, these assistants, particularly those assistants implemented in enterprise environments, are developed for end users within a particular enterprise (e.g., help desk chat bots). Enterprises may invest heavily into virtual assistants to provide their employees with support and to provide them with the information an employee may need to resolve technical issues, look up the meaning of a word or acronym, schedule meetings, or otherwise find answers to them employees' questions.

### SUMMARY

Embodiments of the present disclosure include a method, computer program product, and system for training virtual assistants.

A question and answer pair is received from an external knowledge base. From the question, a set of intents is extracted. Whether the set of intents exceeds a match threshold with a subset of a plurality of intents within an internal knowledge base is determined. In response to determining a match threshold success, associating the question with the subset of intents within the plurality. A virtual assistant is trained to answer the question using the subset of intents.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example network environment of a virtual assistant trainer and recommender, in accordance with embodiments of the present disclosure.

FIG. 2 illustrates an example method for training virtual assistants, in accordance with embodiments of the present disclosure.

FIG. 3 depicts a cloud computing environment according to an embodiment of the present disclosure.

FIG. 4 depicts abstraction model layers according to an embodiment of the present disclosure.

FIG. 5 depicts a high-level block diagram of an example computer system that may be used in implementing embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of virtual assistants, and more particularly to automated training of virtual assistants. While the present disclosure is not necessarily limited to such applications, various aspects of the disclosure may be appreciated through a discussion of various examples using this context.

Virtual assistants are gaining increased use in today's enterprises, as they provide efficient, consistent, and duplicatable assistance to employees for a myriad of issues. Virtual assistants, such as chat bots, may be used to screen IT (information technology) help desk tickets, reserve conference rooms, look up information, place product or service orders, etc. In cases where a virtual assistant can perform the necessary tasks to satisfy the employee, or end-user, the virtual assistant can ease the workload of IT professionals, administrative assistants, and others.

However, training and maintaining virtual assistants with current, up-to-date knowledge and functionality continues to consume large amounts of labor and time and requires a significant amount of human interventions (e.g., by IT experts/professionals). Embodiments of the present disclosure aim to reduce the amount of human intervention necessary to train and maintain any given virtual assistant. In addition to automating the training and maintenance processes, embodiments of the present disclosure further aim to generate training enhancement recommendations that may reduce the need for any further human intervention to a minimum.

A virtual assistant in an enterprise environment may combine one or more application logic module(s) that help to orchestrate the various possible integrations of the virtual assistant with third-party systems/services. In some embodiments, a virtual assistant logic, such as IBM WATSON ASSISTANT, may be utilized for this purpose. The virtual assistant logic may, in embodiments, utilize natural language processing techniques to digest audio inputs and trigger actions/functions based on the intents, entities, and context extracted from the audio input(s).

Currently available virtual assistants perform/trigger actions based on the recognized intent in a given user utterance or question. In order to train these virtual assistants, human experts will typically generate a variety of example utterances/questions that a user may use/intend to trigger a specific action or function. The virtual assistant system uses the expertly-created library of utterances/questions to interact with a user. In some cases, the virtual assistant may learn to adapt to a user's accent or style of phrasing for an utterance.

However, especially in enterprise environments where information changes rapidly, a virtual assistant may suffer from a lack of training when it comes to new or changed information. Put succinctly, the virtual assistant does not have the time to learn by itself—or the human experts do not have time to generate a library of utterances from which the virtual assistant may learn new phrases and/or functions to perform.

Embodiments of the present disclosure contemplate leveraging existing question and answer pairs to improve the recognition of the intent of utterances, create new intents/functions when appropriate and possible, and generate response enhancement recommendations for the human experts to decrease the amount of time any given human expert must spend in training the virtual assistant(s).

In embodiments, an existing repository of question and answer pairs may be utilized to train a virtual assistant. For example, an IT help desk may, during the course of regular operation, generate a database of service tickets. These service tickets may include problem/solution pairs. The problem/solution pairs may be treated, by the virtual assistant trainer and recommender, as question and answer pairs. The service ticket may include additional contextual information and/or metadata, which may assist by adding further details (e.g., OS type, runtime environment details, hardware information, application(s) involved, tangential functions(s) involved, etc.).

In embodiments, each problem/solution (e.g., question and answer) pair may be received by a virtual assistant trainer and recommender, and natural language processing techniques may be used to determine the topics/entities/nouns/objects within a question and/or answer, as well as an intent/verb/computing function described by the question and/or answer. For example, a service ticket may include a question: “How can I reserve conference room 3?” The associated answer may include directions on how to access a room reservation tool and complete a reservation for a room. From the question, the entities “I” and “conference room 3” may be extracted, as well as the intent “conference room reservation.” In other words, the intents may include what a particular virtual assistant is capable of understanding and performing, in the context of topics/requests that would answer a question or otherwise support an end-user. In some embodiments “3” may be considered as additional/contextual information, and may further assist the virtual assistant trainer and recommender by specifying which conference room should be reserved.

In embodiments, the virtual assistant trainer and recommender may, from the extracted intent, recognize that the desired computing function includes a conference room reservation, and this may, in embodiments, be confirmed by the associated answer. The virtual assistant trainer and recommender may perform a match threshold check to ensure that the extracted intent “conference room reservation” sufficiently matches the intents within an internal knowledge base. For example, the already-known intents may include “conference room reservation” or “room reservation,” either of which may, in embodiments, be similar enough to pass a match threshold check. In embodiments, the match threshold check may be performed in parallel, e.g., using Single Instruction Multiple Data (SIMD) techniques.

Once the match threshold check is performed, the virtual assistant trainer and recommender may “know” what the virtual assistant is capable of understanding and performing in the context of the question/answer pair. If the required performance is possible, the virtual assistant trainer and recommender may simply associate the question and/or intent with the answer and/or desired function that performs the solution. In this way, the virtual assistant is trained automatically without the need for human intervention.

If, however, the match threshold check fails (e.g., the virtual assistant either cannot perform the desired solution or does not have sufficient privileges to do so), then the issue may be forwarded to a human expert (e.g., an administrator) in the form of a recommendation as to how the virtual assistant may be improved. In this way, enhancements for a virtual assistant's answer library may be suggested directly to the administrator, thereby reducing the costs associated with finding the deficiencies of a particular virtual assistant, and front-loading the most common/helpful issues/problems.

In yet other embodiments, a virtual assistant trainer and recommender may, in response to a match threshold failure, search for/discover a “new” computing function not previously associated with the list of intents within the internal knowledge base. In other words, the virtual assistant trainer and recommender may determine that the virtual assistant can perform/execute a function it has not previously performed, based on a list of available functions at an application and/or OS (operating system) level. Once this “new” function has been discovered, it may be embodied as an intent within the internal knowledge base and associated with a question or similar utterance to provide functionality in response to the utterance/question. In this way, the virtual assistant may learn, as a result of the virtual assistant trainer and recommender's work, a new skill/response, all without human intervention.

Using the aforementioned techniques, a virtual assistant may be trained to perform a learned answer in response to any of the ingested questions/extracted intents whether that answer was previously known, or newly acquired (e.g., self-taught using the virtual assistant trainer and recommender). In some embodiments, a human expert may receive a recommendation for answering a particular question with a recommended answer (e.g., for review/approval prior to implementation), and the virtual assistant may, upon approval by the human expert (e.g., administrator) incorporate the functionality/answer for the particular question/utterance.

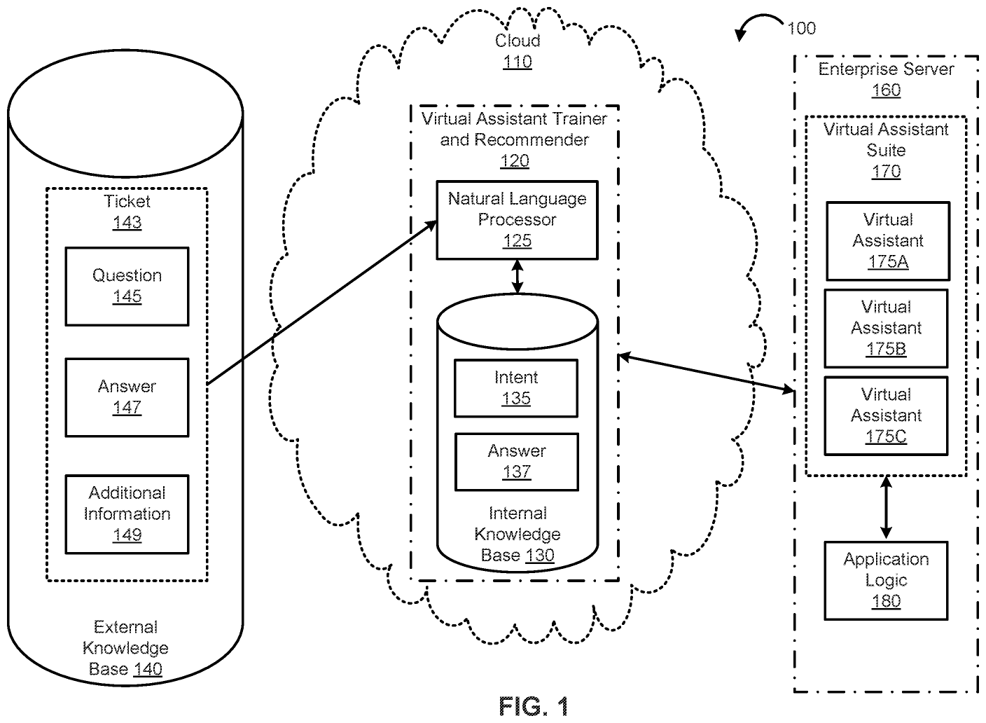

Referring now to FIG. 1, illustrated is an example network environment 100 of a virtual assistant trainer and recommender 120, in accordance with embodiments of the present disclosure. Example network environment 100 may include, for example, an external knowledge base 140, cloud 110, and enterprise server 160. In some embodiments, certain functions of external knowledge base 140, cloud 110, and enterprise server 160 may be implemented at a location different from the depiction.

According to embodiments, the external knowledge base 140, cloud 110, and enterprise server 160 may be comprised of computer systems (e.g., may contain the same or similar components as computer system 501). The external knowledge base 140, cloud 110, and enterprise server 160 may be configured to communicate with each other through an internal or external network interface (not shown). The network interfaces may be, e.g., modems, wireless network adapters, Ethernet adapters, etc. The external knowledge base 140, cloud 110, and enterprise server 160 may be further equipped with displays or monitors (not shown). Additionally, external knowledge base 140, cloud 110, and enterprise server 160 may include optional input devices (e.g., a keyboard, mouse, scanner, or other input device), and/or any commercially available or custom software (e.g., image processing software, object identification software, etc.). In some embodiments, external knowledge base 140, cloud 110, and enterprise server 160 may include additional servers, desktops, laptops, IoT (Internet of Things) devices, or hand-held devices.

External knowledge base 140, cloud 110, and enterprise server 160 may further include additional storage (e.g., storage interface 514). The storage may include, for example, virtualized disk drives, physical hard disk drives, solid state storage drives, or any other suitable storage media. In some embodiments, workload data and metadata may be stored, temporarily or permanently.

The external knowledge base 140, cloud 110, and enterprise server 160 may be distant from each other and may communicate over a network (not shown). In embodiments, the cloud 110 may be a central hub from which external knowledge base 140 and enterprise server 160 can establish a communication connection, such as in a client-server networking model. In other embodiments, enterprise server 160 may act as such a hub for the external knowledge base 140 and cloud 110. In some embodiments, the external knowledge base 140, cloud 110, and enterprise server 160 may be configured in any other suitable network relationship (e.g., in a peer-to-peer configuration or using another network topology).

In embodiments, the connections among the components of networking environment 100 can be implemented using any number of any suitable communications media. For example, a wide area network (WAN), a local area network (LAN), the Internet, or an intranet. In certain embodiments, the external knowledge base 140, cloud 110, and enterprise server 160 may be local to each other and communicate via any appropriate local communication medium. For example, the external knowledge base 140, cloud 110, and enterprise server 160 may communicate using a local area network (LAN), one or more hardwire connections, a wireless link or router, or an intranet. In some embodiments, external knowledge base 140, cloud 110, and enterprise server 160, and any other devices, may be communicatively coupled using a combination of one or more networks and/or one or more local connections. For example, the enterprise server 160 may be hardwired to the virtual assistant trainer and recommender 120 (e.g., connected with an Ethernet cable) while a third client device may communicate with the enterprise server 160 over a network, such as an intranet or the Internet.

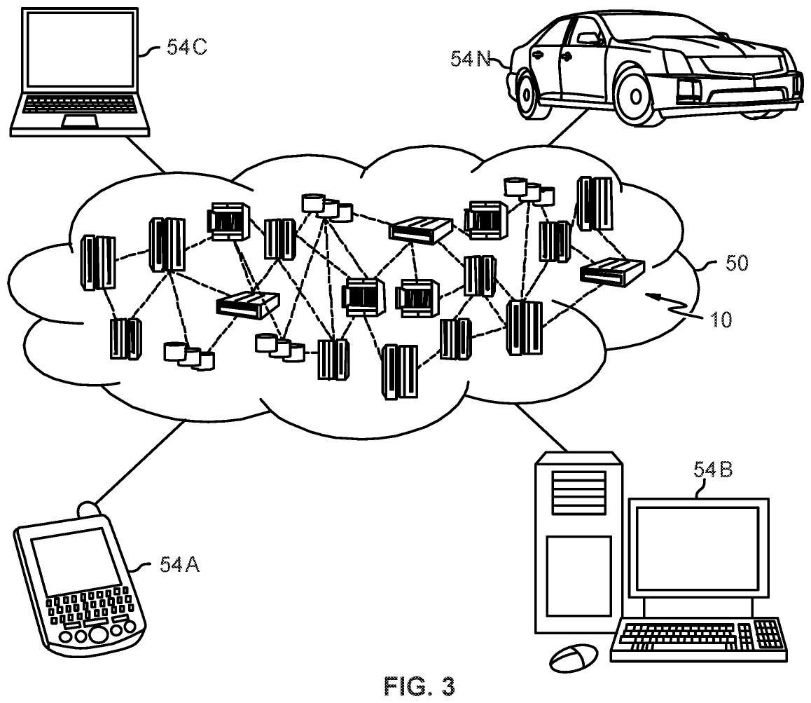

In some embodiments, the network environment 100 can be implemented within, or as a part of, a cloud computing environment, as depicted. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over a network. Further detail regarding cloud computing is given with respect to FIGS. 3 & 4.

According to embodiments, enterprise server 160 may include a virtual assistant suite 170 and application logic 180. In embodiments, the virtual assistant suite 170 may include virtual assistants 175A-C. In some embodiments, virtual assistant suite 170 may include a greater or fewer number of virtual assistants, and the virtual assistants may be trained for various purposes (e.g., IT help desk assistance, flight reservation assistance, product ordering assistance, grounds/building maintenance scheduling assistance, etc.). In some embodiments, a given virtual assistant may be trained/used by employees of the enterprise, or it may be a product/service of the enterprise offered to the public, other enterprises, etc. In some embodiments, application logic may contain, as described herein, a natural language processor (not shown) and a library of computing functions (not shown) available for execution by a particular virtual assistant (e.g., virtual assistant 175A-C).

In embodiments, external knowledge base 140 may include, for example, a library of tickets 143. Each ticket 143 may include a question 145, an answer 147, and additional information 149. In embodiments, each question 145 may be an end-user submitted question or request for service/assistance. Each answer 147 may be an answer to the question 145, generated by a human expert or a highly-rated (e.g., vetted and effective; approved by an administrator) answer generated by a virtual assistant. Additional information 149 may include contextual information (e.g., application version, OS type, hardware information, product specifications, etc.) for the question/answer pair for the ticket 143. In some embodiments, additional information 149 may shed light on the meaning of a particular question 145 or answer 147. In some embodiments, external knowledge base 140 may reside within cloud 110 or enterprise server 160.

Virtual assistant trainer and recommender 120 may reside in part, or primarily, within cloud 110, to allow multiple enterprises to access the functionality of the virtual assistant trainer and recommender 120. In some embodiments, virtual assistant trainer and recommender 120 may reside within the enterprise server 160. Virtual assistant trainer and recommender 120 may include a natural language processor 125 (e.g., similar to application logic 180). In some embodiments, virtual assistant trainer and recommender 120 may utilize/share the natural language processor within application logic 180.

Virtual assistant trainer and recommender 120 may further include an internal knowledge base 130. In some embodiments, internal knowledge base 130 may reside within enterprise server 160. Internal knowledge base 130 may include a library of intents 135 and answers 137. Intent 135 may include, for example, a list of intents extracted from question(s) 145. Answer(s) 137 may include, for example, the answer(s) 147 and/or a list of computing functions associated with answer(s) 147.

As a functional example of an embodiment, question and answer pairs may be received, from external knowledge base 140, by the virtual assistant trainer and recommender 120, and natural language processor 125 may extract an intent 135 therefrom. Intent 135 may be compared to a list of functions (e.g., intents) within application logic 180. If a match threshold is passed, then the question 145 may be associated with the intent 135 or its equivalent function within application logic 180. Such an association may be stored within internal knowledge base 130, within application logic 180, and/or within a particular virtual assistant 175A-C.

If, however, the match threshold is failed, the virtual assistant may generate a wholly new intent, based on the question and answer pair and a set of available computing functions. The intent 135, of question 145, may be incorporated into the internal knowledge base 130, application logic 180, and/or virtual assistants 175A-C as an initialization utterance for the intent/function. In some embodiments, the new intent and associated function may be sent to an administrator for review/approval prior to use in training a virtual assistant 175A-C.

It is noted that FIG. 1 is intended to depict the representative major components of an example network environment 100. In some embodiments, however, individual components may have greater or lesser complexity than as represented in FIG. 1; components other than or in addition to those shown in FIG. 1 may be present, and the number, type, and configuration of such components may vary.

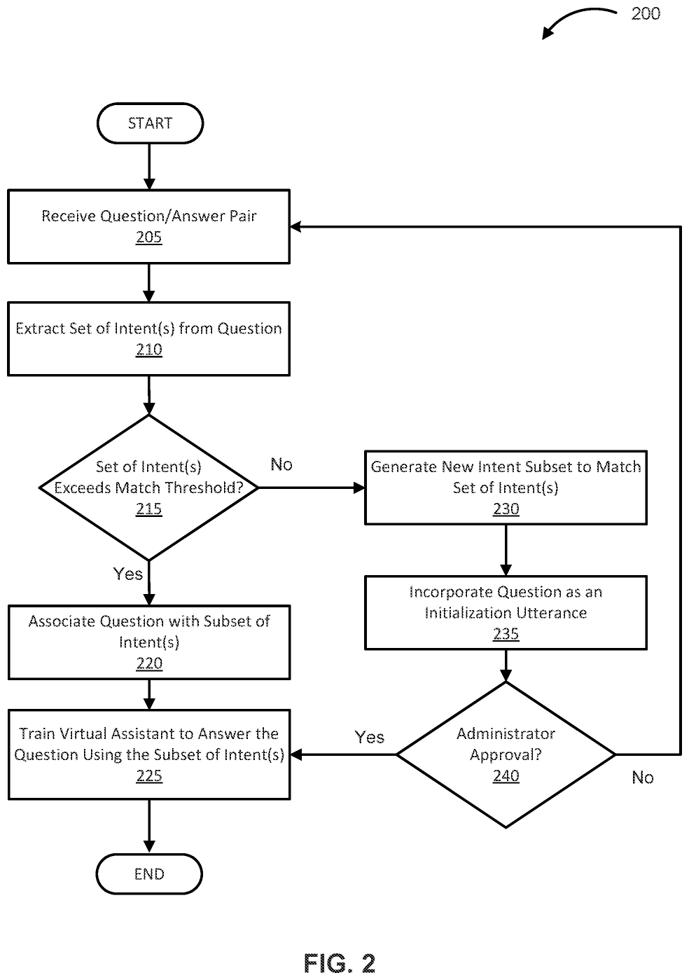

Referring now to FIG. 2, illustrated is an example method 200 for training a virtual assistant, according to embodiments of the present disclosure. Example method 200 may begin at 205, where a question/answer pair is received, as described herein. A question/answer pair may, in embodiments, include a problem/solution pair, such as an IT help desk ticket, an internet search query and the results of said query, or any other utterance or input and the associated response thereto. In some embodiments, the question/answer pair(s) may be vetted for quality prior to incorporation within example method 200. An example of a question/answer pair could be: Question—What time is it in Prague? Answer—It is 1400 hours in Prague. Additional/contextual information may include information regarding the fact that it is not always 1400 hours in Prague, but the time in Prague may be calculated as Central US time+7 hours, or that the time in Prague may be found by requesting the information from a server local to Prague.

At 210, a set of intent(s) is extracted from the question(s). An intent may include, as described herein, an intention of an end-user's question/request, which may include the execution/performance of one or more computing functions. In some embodiments, entities (e.g., topics/nouns/objects) and context (e.g., additional information within, or tangential to, a user's utterance/input) may also be extracted to give further detail to an intent (e.g., OS type/version, application version, hardware information, etc.). Given the example question/answer above, the intent could be the function “Central US time+7 hours” or the function “query server local to Prague for current time.”

At 215, it is determined whether the set of intents exceeds a match threshold. As described herein, the match threshold may be a similarity check comparing the set of extracted intents to a plurality of already-known intents (e.g., functions within application logic 180 or a set of intent(s) 135 within an internal knowledge base 130) to determine whether a subset of the plurality of already-known intents matches, sufficiently, the extracted set of intents. For example, using the above example, the match threshold could be exceeded if the ability to query, for a current timestamp, a server local to Prague exists, or if the virtual assistant has, within its associated application logic, the ability to calculate “Current US time+7.”

If, at 215, the match threshold is exceeded, the question from the question/answer pair may be associated with the subset of intent(s) at 220. In embodiments, this may be accomplished via a relational database, text index, table, or other suitable data structure; this may be a part of an internal knowledge base (e.g., internal knowledge base 130) or an application logic (e.g., application logic 180).

At 225, the virtual assistant in question may be trained to answer the question from the question/answer pair using the subset of intent(s). In other words, a virtual assistant who has, for example, never before been asked the for the current time in Prague may, in this way, add the functionality to do so without human intervention.

If, however, at 215, the set of extracted intents fails the match threshold (e.g., there is no matching intent/function found), the method may proceed to 230 where a new intent subset is generated to match the set of extracted intent(s). As described herein, this may include analyzing a list of OS and/or application functions to find a function similar to the intent(s) extracted from the question. Using the time conversion example, if no time query function exists, and no server local to Prague is known, the OS and/or other applications/sources (e.g., the Internet) may be queried using the intent to find similar functions/intents, from which the new intent subset may be generated.

At 235, the question from the question/answer pair may be incorporated as an initialization utterance and associated to the generated intent subset. For example, the found functions may be associated with the utterance from the question such that uttering the question triggers the function(s) to execute in order to generate an answer similar, or identical, to the answer of the question/answer pair. In embodiments, full implementation of this functionality may be immediate, or it may require administrative approval, as described herein.

Method 200 is contemplated to require administrative approval at 240 (e.g., the newly generated subset of intents may be presented to an administrator as a recommendation for an enhanced answer). If approved, the newly generated intent subset may be used to train a virtual assistant to respond to the question using the newly generated intent subset, and reporting the answer therefrom to an end-user (e.g., notifying a user), when queried by said end-user and as described herein.

However, if the newly generated intent subset is not approved, it may be discarded and the method may return to 205, where a next question/answer pair is received.

It is to be understood that although this disclosure includes a detailed description on cloud computing, implementation of the teachings recited herein are not limited to a cloud computing environment. Rather, some embodiments of the present invention are capable of being implemented in conjunction with any other type of computing environment now known or later developed.

Cloud computing is a model of service deliver for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

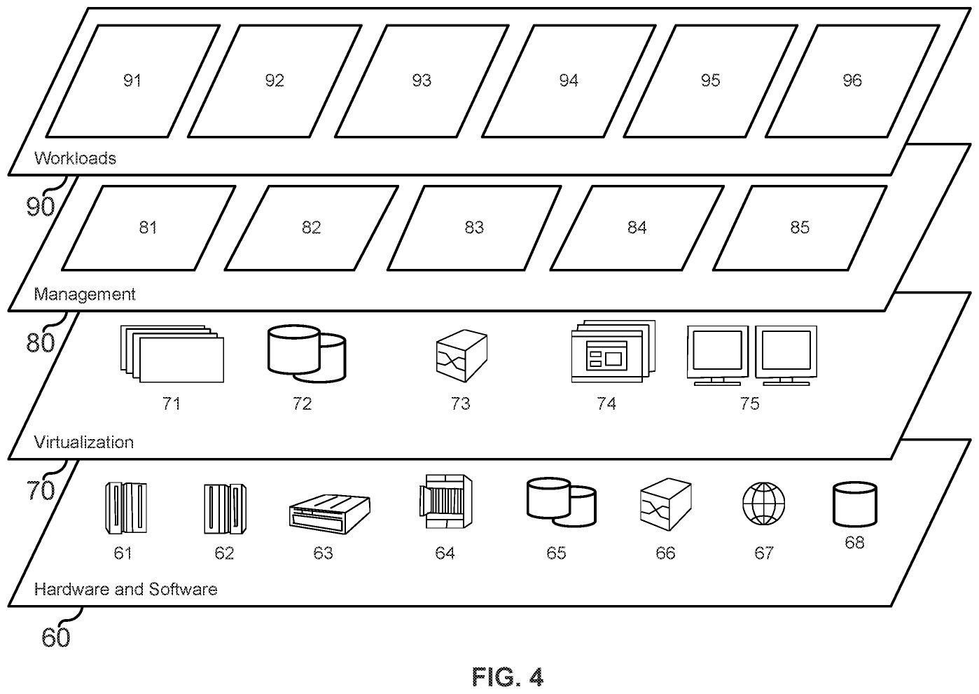

Referring now to FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 4, a set of functional abstraction layers provided by cloud computing environment 50 (FIG. 3) is shown. It should be understood in advance that the components, layers, and functions shown in FIG. 4 are intended to be illustrative only and some embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and virtual assistant training 96.

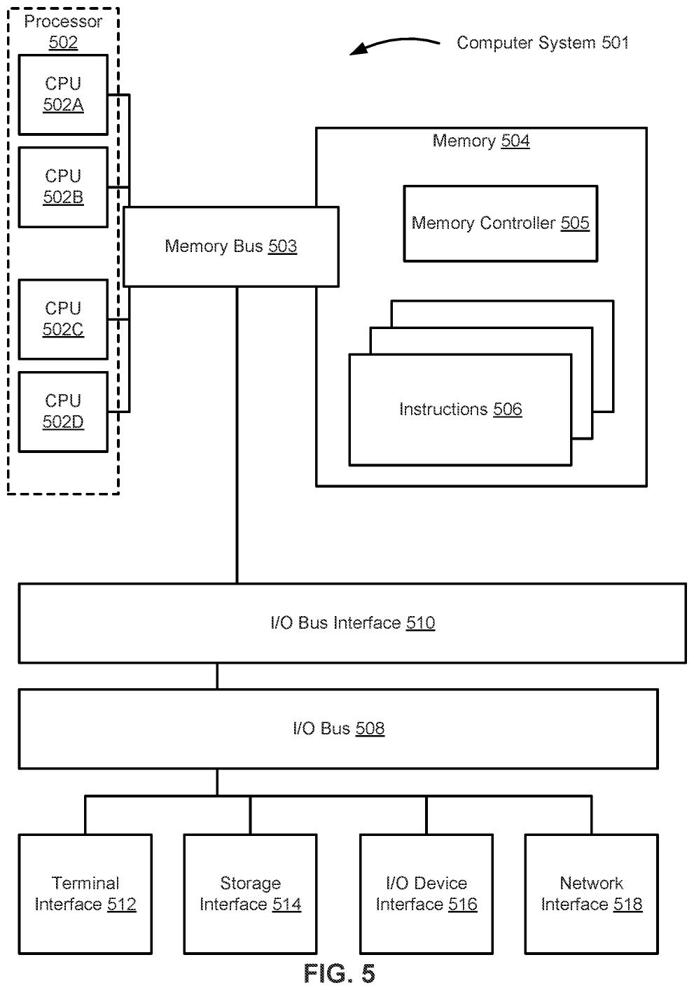

Referring now to FIG. 5, shown is a high-level block diagram of an example computer system 501 that may be configured to perform various aspects of the present disclosure, including, for example, method 200, described in FIG. 2. The example computer system 501 may be used in implementing one or more of the methods or modules, and any related functions or operations, described herein (e.g., using one or more processor circuits or computer processors of the computer), in accordance with embodiments of the present disclosure. In some embodiments, the illustrative components of the computer system 501 comprise one or more CPUs 502, a memory subsystem 504, a terminal interface 512, a storage interface 514, an I/O (Input/Output) device interface 516, and a network interface 518, all of which may be communicatively coupled, directly or indirectly, for inter-component communication via a memory bus 503, an I/O bus 508, and an I/O bus interface unit 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may comprise one or more levels of on-board cache. Memory subsystem 504 may include instructions 506 which, when executed by processor 502, cause processor 502 to perform some or all of the functionality described above with respect to FIG. 2.

In some embodiments, the memory subsystem 504 may comprise a random-access semiconductor memory, storage device, or storage medium (either volatile or non-volatile) for storing data and programs. In some embodiments, the memory subsystem 504 may represent the entire virtual memory of the computer system 501 and may also include the virtual memory of other computer systems coupled to the computer system 501 or connected via a network. The memory subsystem 504 may be conceptually a single monolithic entity, but, in some embodiments, the memory subsystem 504 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 504 may contain elements for control and flow of memory used by the CPU 502. This may include a memory controller 505.

Although the memory bus 503 is shown in FIG. 5 as a single bus structure providing a direct communication path among the CPUs 502, the memory subsystem 504, and the I/O bus interface 510, the memory bus 503 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smart phone, mobile device, or any other appropriate type of electronic device.

It is noted that FIG. 5 is intended to depict the representative example components of an exemplary computer system 501. In some embodiments, however, individual components may have greater or lesser complexity than as represented in FIG. 5, components other than or in addition to those shown in FIG. 5 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for virtual assistant training, comprising:
receiving a question and answer pair from an external knowledge base;
extracting, from the question, a set of intents;
determining whether the set of intents exceeds a match threshold with a subset of a plurality of intents within an internal knowledge base;
in response to determining a match threshold success, associating the question with the subset of intents within the plurality; and
training the virtual assistant to answer the question using the subset of intents.

2. The method of claim 1, further comprising:
receiving, from a user, a second question;
extracting a second set of intents from the second question;
determining the second set of intents matches the subset of intents; and
notifying the user of the answer.

3. The method of claim 1, further comprising:
receiving a second question and answer pair from the external knowledge base;
extracting, from the second question, a second set of intents;
determining the second set of intents fails the match threshold with a second subset of the plurality of intents within the internal knowledge base;
generating a new subset of intents within the plurality, based on the second set of intents; and
generating an enhanced answer to the second question by associating the second question with the new subset of intents.

4. The method of claim 3, further comprising:
receiving, from a user, a second question;
extracting a second set of intents from the second question;
determining the second set of intents matches the new subset of intents; and
notifying the user of the enhanced answer.

5. The method of claim 4, wherein generating the enhanced answer includes receiving an approval from an administrator.

6. The method of claim 5, further comprising:
receiving, from a second user, a third question;
extracting a third set of intents from the third question;
determining the third set of intents matches the new subset of intents; and
automatically notifying the second user of the enhanced answer.

7. The method of claim 6, wherein software is provided as a service to train the virtual assistant.

8. A computer program product for virtual assistant training, the computer program product comprising a computer readable storage medium having program instructions embodied therewith, the program instructions executable by a device to cause the device to:
receive a question and answer pair from an external knowledge base;
extract, from the question, a set of intents;
determine whether the set of intents exceeds a match threshold with a subset of a plurality of intents within an internal knowledge base; and
in response to determining a match threshold success:
associate the question with the subset of intents within the plurality; and
train the virtual assistant to answer the question using the subset of intents.

9. The computer program product of claim 8, wherein the program instructions further cause the device to:
receive, from a user, a second question;
extract a second set of intents from the second question;
determine the second set of intents matches the subset of intents; and
notify the user of the answer.

10. The computer program product of claim 8, wherein the program instructions further cause the device to:
in response to determining that the set of intents fails to exceed the match threshold, generate a new subset of intents within the plurality, based on the set of intents; and
generate an enhanced answer to the question by associating the question with the subset of intents.

11. The computer program product of claim 10, wherein the program instructions further cause the device to:
receive, from a user, a second question;
extract a second set of intents from the second question;
determine the second set of intents matches the subset of intents; and
notify the user of the enhanced answer.

12. The computer program product of claim 11, wherein generating the enhanced answer includes receiving an approval from an administrator.

13. The computer program product of claim 12, wherein the program instructions further cause the device to:
receive, from a second user, a third question;
extract a third set of intents from the third question;
determine the third set of intents matches the subset of intents; and
automatically notify the user of the enhanced answer.

14. The computer program product of claim 13, wherein software is provided as a service to train the virtual assistant.

15. A system for virtual assistant training, the system comprising:
a memory subsystem, with program instructions included thereon; and
a processor in communication with the memory subsystem, wherein the program instructions cause the processor to:
receive a question and answer pair from an external knowledge base;
extract, from the question, a set of intents;
determine whether the set of intents exceeds a match threshold with a subset of a plurality of intents within an internal knowledge base; and
in response to determining a match threshold success:
associate the question with the subset of intents within the plurality; and
train the virtual assistant to answer the question using the subset of intents.

16. The system of claim 15, wherein the program instructions further cause the processor to:
receive, from a user, a second question;
extract a second set of intents from the second question;
determine the second set of intents matches the subset of intents; and
notify the user of the answer.

17. The system of claim 15, wherein the program instructions further cause the processor to:
in response to determining that the set of intents fails to exceed the match threshold, generate a new subset of intents within the plurality, based on the set of intents; and
generate an enhanced answer to the question by associating the question with the new subset of intents.

18. The system of claim 17, wherein the program instructions further cause the processor to:
receive, from a user, a second question;
extract a second set of intents from the second question;
determine the second set of intents matches the new subset of intents; and
notify the user of the enhanced answer.

19. The system of claim 18, wherein generating the enhanced answer includes receiving an approval from an administrator.

20. The system of claim 19, wherein the program instructions further cause the processor to:
receive, from a second user, a third question;
extract a third set of intents from the third question;
determine the third set of intents matches the subset of intents; and
automatically notify the user of the enhanced answer.
